(19) United States
(12) Patent Application Publication
(10) Pub. No.: US 2015/0259635 A1
(43) Pub. Date: Sep. 17, 2015

(54) METHOD FOR PREPARING FERMENTED GINKGO BILOBA BEVERAGE USING HEAT-RESISTANT AMYLASE

(71) Applicant: UNIVERSITY OF ULSAN FOUNDATION FOR INDUSTRY COOPERATION, Ulsan (KR)

(72) Inventors: Dae Sil Lee, Ulsan (KR); Hun Taeg Chung, Ulsan (KR); Sung Hoon Back, Ulsan (KR); Seung Je Woo, Ulsan (KR); Sun Oh Jeong, Jeollabuk-do (KR)

(21) Appl. No.: 14/431,767

(22) PCT Filed: Sep. 24, 2013
(86) PCT No.: PCT/KR2013/008521

§ 371 Date: Mar. 26, 2015

(30) Foreign Application Priority Data
Sep. 28, 2012 (KR) 10-2012-0109061

(51) Int. Cl. C12G 3/02

(52) U.S. Cl. CPC C12G 3/02

(57) ABSTRACT

Disclosed is a method of preparing ginkgo fermented liquor, the method including: preparing ginkgo hydrolysate by mixing ginkgo with heat-tolerant amylase to allow an enzyme reaction at a temperature from about 70° C. to about 100° C.; and mixing the ginkgo hydrolysate with a fermentation strain to allow fermentation. According to the embodiment, use of the heat-tolerant α-amylase leads to production of hydrolysate at a high temperature, and accordingly, hydrolysis and solubility of the resultant may be improved. In addition, the resultant is prevented from being contaminated with other microorganisms, thereby preventing decomposition of ginkgo and preparing ginkgo fermented liquor having ginkgo's own taste and flavor and a physiologically active material.

### TECHNICAL FIELD

The present invention relates to a method of preparing ginkgo fermented liquor using heat-tolerant amylase, fermented liquor prepared by the method, and ginkgo brandy that is distilled from the fermented liquor.

### BACKGROUND ART

Ginkgo is a yellow ripe fruit of a female ginkgo tree in October, the yellow ripe fruit having a diameter of about 2 cm. The exotesta of ginkgo is succulent and stinks. An egg-shaped, round seed with white solid mesotesta having two edges inside the exotesta may be called a ginkgo nut or a ginkgo white fruit. The endotesta with a brown film inside the mesotesta may contain turquoise endosperm.

Ginkgo refers to turquoise endosperm from which the mesotesta and endotesta of the ginkgo nut (white fruit) of the ginkgo trees are removed. Ginkgo has been widely used as a subsidiary material in various foods since ginkgo has excellent taste and flavor and is rich with nutrients. Ginkgo contains, in addition to carbohydrate (34.5%), protein (4.7%), and fat (1.7%), a physiologically active material, such as gibberellin, cytokinin, carotene, vitamin B2, potassium, phosphorus, and iron. Ginkgo also contains elgosterine and cyanophore glycoside including cyanogen that is required to produce vitamin B12. Accordingly, ginkgo may be used in terms of strengthening pulmonary protection or soothing the skin, and may be used for the treatment of phlegm, asthma, hangovers, body fatigue, feminine leucorrhea, or children's enuresis.

Meanwhile, liquor is classified into fermented liquor, compounded liquor, and distilled liquor, according to a preparation method thereof. Here, the fermented liquor is prepared by fermenting sugars or starches in grains, fruits, and other materials. In addition, an alcohol content in the fermented liquor is typically low in a range from about 1% to about 18%. In this regard, beer, wine, unrefined rice wine, and refined rice wine belong to the fermented liquor.

The fermented liquor contains large amounts of more than hundred kinds of trace elements, such as organic acids, sugars, amino acids, and vitamins, which are not found in the distilled liquor. Accordingly, the fermented liquor has been found to have excellent efficacy of anticancer effect. It is also discovered that domestic traditional fermented liquor contains none of ethyl carbamate, or contains ethyl carbamate in a trace amount below the standards for hazardous materials, wherein the ethyl carbamate is a problematic carcinogen in foreign liquor.

Meanwhile, in regard to the related art disclosing liquor using ginkgo as a material, KR 2004-0064517 (GINKGO NUT ADDED FUNCTIONAL LIQUOR AND PREPARATION METHOD THEREOF) is characterized by: removing external skin and cyanide-containing internal skin from ginkgo nuts; pulverizing the skin-removed ginkgo nuts; and mixing liquid ginkgo nut juice in an amount from about 0.9% to about 29.9% based on a total weight of starch materials. However, the invention disclosed in the related art relates to a typical method of preparing liquor using a starch material as a main material, without disclosing any technique using gingko's own glucose as a source material for fermentation through pre-treatment with amylase.

### DETAILED DESCRIPTION OF THE INVENTION

### Technical Problem

The present invention provides a method of preparing ginkgo fermented liquor by hydrolyzing large amounts of α-glucans that are included in ginkgo by using amylase in a high efficient manner, and using hydrolysate or oligosaccharide obtained therefrom as a source material for fermentation.

In addition, the present invention provides ginkgo fermented liquor prepared according to the method of preparing ginkgo fermented liquor, and ginkgo brandy prepared by distilling the ginkgo fermented liquor.

### Technical Solution

In order to solve the technical problem above, the present invention provides a method of ginkgo fermented liquor, the method including: preparing ginkgo hydrolysate by mixing ginkgo with heat-tolerant amylase to allow an enzyme reaction at a temperature from about 70° C. to about 100° C.; and mixing the ginkgo hydrolysate with a fermentation strain to allow fermentation.

In addition, the present invention provides a method of preparing ginkgo brandy, the method including: distilling the ginkgo fermented liquor, and ginkgo brandy prepared according to the method of preparing ginkgo brandy.

### Advantageous Effects

According to the present invention, use of heat-tolerant α-amylase leads to production of hydrolysate at a high temperature, and accordingly, hydrolysis and solubility of the resultant may be improved. In addition, the resultant is prevented from being contaminated with other microorganisms, thereby preventing decomposition of ginkgo and preparing ginkgo fermented liquor having ginkgo's own taste and flavor and a physiologically active substance.

### DESCRIPTION OF THE DRAWINGS

FIG. 1 is a diagram showing the result of thin-layer chromatography with respect to ginkgo oligosaccharide and ginkgo hydrolysate that are prepared according to the method described above (wherein G refers to glucose (control group); H refers to ginkgo oligosaccharide; and M refers to ginkgo hydrolysate)

### BEST MODE

The present invention provides a method of preparing ginkgo fermented liquor, the method including: preparing ginkgo hydrolysate by mixing ginkgo with heat-tolerant amylase to allow an enzyme reaction at a temperature from about 70° C. to about 100° C.; and mixing the ginkgo hydrolysate with a fermentation strain to allow fermentation.

In an embodiment of the present invention, the heat-tolerant amylase may be α-amylase derived from a Thermotoga maritime (T. maritime) strain. The heat-tolerant amylase may be obtained by which Escherichia coli (E. coli) cells, which are transformed with α-amylase genes of the T. maritime strain, are cultured to allow induction of enzyme synthesis and purification of the enzyme.

In an embodiment of the present invention, use of the heat-tolerant α-amylase may allow enzymatic hydrolysis at a high temperature. Here, the temperature at which the hydrolysis occurs is in a range from about 70° C. to about 100° C., about 80° C. to about 95° C., or about 80° C. to about 90° C., but the temperature range is not limited thereto.

The temperature range above may lead to increased hydrolysis and solubility of the resultant. In addition, the resultant may be prevented from being contaminated with other microorganisms, thereby preventing decomposition of ginkgo and preparing ginkgo fermented liquor having ginkgo's own taste and flavor and a physiologically active material.

In addition, ginkgo may be ground in advance upon the enzymatic hydrolysis, and the hydrolysis may be performed for about 1 to about 20 hours or to about 5 to about 15 hours, but the reaction time is not limited thereto.

In an embodiment of the present invention, the enzymatic hydrolysis may be performed by applying a microwave at a temperature from about 85° C. to about 95° C. in a microwave. In this regard, the reaction time of the hydrolysis may be reduced.

The ginkgo hydrolysate obtained by the completion of the hydrolysis may be in the form of an aqueous mixture having almost no viscosity, and the aqueous mixture may be mixed with a fermentation strain to allow fermentation.

In an embodiment of the present invention, the method of preparing ginkgo fermented liquor may further include a step of preparing ginkgo oligosaccharide from a supernatant obtained by centrifugation of the ginkgo hydrolysate. Afterwards, the ginkgo oligosaccharide may be subjected to fermentation.

In an embodiment of the present invention, the fermentation strain may be selected from strains having good capability of fermenting the ginkgo hydrolysate, and preferably, may be at least one of yeast and aspergillus. Here, the fermentation strain may be used in an amount from about 0.1 to about 20 parts by weight, or from about 0.2 to about 15 parts by weight, based on 100 parts by weight of the ginkgo hydrolysate or the ginkgo oligosaccharide. The fermentation may be performed at room temperature, i.e., a temperature in a range from about 10° C. to about 30° C., for about 10 to about 30 days, and then, the fermentation strain may be completely in neglect until the end of fermentation.

In an embodiment of the present invention, before the fermentation starts, at least one selected from the groups consisting of rice, barley, corn, potato, sweet potato, foxtail millet, sorghum, proso millet, and bean may be further mixed in addition to the ginkgo hydrolysate or the ginkgo oligosaccharide.

In an embodiment of the present invention, the rice may be in the form of porridge that is prepared by boiling the rice put in water. Alternatively, the rice may be prepared in the form of rice hydrolysate produced by the heat-tolerant amylase or in the form of rice oligosaccharide from a supernatant obtained by centrifugation of the rice hydrolysate, but the rice form is not limited thereto. A mixture with the rice or other grains may be used to prepare compounded fermented liquor having more alcohol contents and better smooth taste.

After the fermentation starts, the ginkgo fermented liquor having alcohol contents in a range from about 5 to about 15% may be obtained by filtration and mixing an undiluted solution of liquor with subsidiary materials.

In addition, distillation of the fermented liquor may lead to preparation of ginkgo brandy.

In addition, the present invention provides the ginkgo fermented liquor or the ginkgo brandy prepared according to the fermentation described above, wherein the ginkgo brandy has a great alcohol content (in a range from about 35% to about 55%). In addition, the ginkgo fermented liquor and the ginkgo brandy may be blended together so as to prepare a blended brandy, and in this regard, the ginkgo brandy having a great alcohol content may be mixed with the ginkgo fermented liquor so as to prepare blended brandy that is appropriately drinkable.

### MODE OF THE INVENTION

Hereinafter, the present inventive concept will be described in further detail with reference to the following examples. These examples are for illustrative purposes only and are not intended to limit the scope of the present invention.

### EXAMPLE 1

### Preparation of Heat-Tolerant α-Amylase

Escherichia coli (E. coli) cells, which were transformed with α-amylase genes of the hyperthermophilic bacterium Thermotoga maritima (T. maritima), were cultured for 12 hours at a temperature of 37° C. in a fermentor (2 L, Korean Fermentor) at a speed of 1,000 rpm. Next, 1 mL of isopropyl-1-thio-β-D-galactopyranoside (IPTG, final concentration of 1 M) was added thereto to induce gene expression, and 3 hours later, the E. coli cells were centrifuged and collected. The collected E. coli cells (7 g of wet cell/35 mL of phosphate buffered saline) were disrupted using an ultrasonicator, and then, were subjected to heat treatment at a temperature of 80° C. for 30 minutes. The E. coli cells were centrifuged to separate the supernatant containing the α-amylase, thereby obtaining high purity heat-tolerant α-amylase.

### EXAMPLE 2

### Preparation of Ginkgo Oligosaccharide

100 g of ginkgo powder was added to 100 mL of water, and then, the mixture was boiled for 5 minutes in a microwave to prepare a ginkgo broth. Next, to maximize activity of α-amylase in the ginkgo broth, 100 μL of NaCl (100 mM), 100 μL of CaCl₂ (100 mM), and 10 mL of the α-amylase of Example 1 were added to the ginkgo broth, and accordingly, the mixed ginkgo broth was put in a microwave (for 30 minutes) to induce hydrolysis, and to continuously allow an enzyme reaction at a temperature of 90° C. for 10 hours, thereby preparing ginkgo-derived hydrolysate. The ginkgo-derived hydrolysate was centrifuged for 30 minutes at a speed of 8,000 rpm at a temperature of 4° C., so as to separate the supernatant containing the ginkgo oligosaccharide.

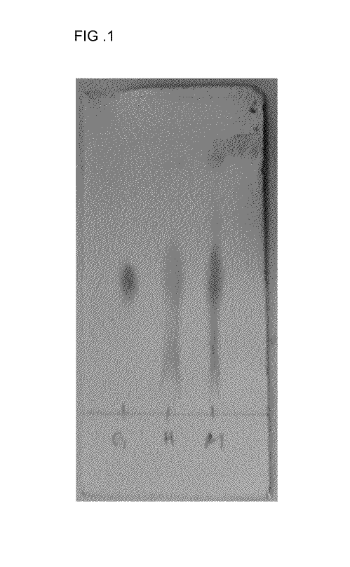

FIG. 1 is a diagram showing the result of thin-layer chromatography with respect to the ginkgo oligosaccharide and the ginkgo hydrolysate that were prepared according to the method described above (wherein G refers to glucose (control group); H refers to ginkgo oligosaccharide; and M refers to ginkgo hydrolysate). Referring to FIG. 1, the presence of compounds having a greater molecular weight than the ginkgo hydrolysate and the ginkgo oligosaccharide was confirmed.

### EXAMPLE 3

### Malt/Yeast Fermentation of Ginkgo Hydrolysate

100 g of malt and 2 g of yeast were added to 1,000 mL of the ginkgo oligosaccharide in a glass fermentation container (2,000 mL) for 2 weeks to allow fermentation at room temperature. The alcohol content in the obtained ginkgo fermented liquor was about 5%.

### EXAMPLE 4

### Yeast Fermentation of Ginkgo Oligosaccharide

1,000 mL of the ginkgo oligosaccharide of Example 2 and 2 g of yeast were added to a glass fermentation container (2,000 mL) supplemented with glucose as a carbon source (10 g of glucose×10 times) for 2 weeks to allow fermentation at room temperature. The alcohol content in the obtained ginkgo fermented liquor was about 11%.

### EXAMPLE 5

### Malt/Yeast Fermentation of Mixture of Ginkgo Oligosaccharide and Rice Porridge

100 g of malt and 2 g of yeast were added to a mixture of 1,000 mL of the ginkgo oligosaccharide of Example 2 and rice porridge (100 g of rice/1,000 mL of water) in a glass fermentation container (2,000 mL) for 2 weeks to allow fermentation at room temperature. The alcohol content in the obtained ginkgo fermented liquor was about 7%.

### EXAMPLE 6

### Malt/Yeast Fermentation of Mixture of Ginkgo Oligosaccharide and Rice Oligosaccharide

100 g of rice was added to 1,000 mL of water, and then, the mixture was boiled to prepare rice porridge. Next, 100 μL of NaCl (100 mM), 100 μL of CaCl₂ (100 mM), and 10 mL of the α-amylase of Example 1 were added to the rice porridge, and accordingly, the mixed rice porridge was put in a microwave (for 30 minutes) to induce hydrolysis, and to continuously allow an enzyme reaction at a temperature of 90° C. for 10 hours, thereby preparing rice-derived hydrolysate. The rice-derived hydrolysate was centrifuged for 30 minutes at a speed of 8,000 rpm at a temperature of 4° C., so as to separate the supernatant containing the rice oligosaccharide.

100 g of malt and 2 g of yeast were added to a mixture of 1,000 mL of the rice oligosaccharide and 1,000 mL of the ginkgo oligosaccharide of Example 2 in a glass fermentation container (4,000 mL) for 2 weeks to allow fermentation at room temperature. The alcohol content in the obtained ginkgo fermented liquor was about 9%.

### EXAMPLE 7

### Preparation of Ginkgo Distilled Liquor

The ginkgo fermented liquor prepared according to Examples 3 to 6 was centrifuged for 30 minutes at a speed of 8,000 rpm at a temperature of 4° C., and then, the supernatant obtained therefrom was added to a distillation apparatus to allow distillation at a temperature of 75° C. or less. Methanol that was distilled at a temperature of 75° C. or less was withdrawn while ginkgo distilled liquor that was distilled at a temperature from about 75° C. to about 85° C. was obtained. Here, the alcohol content in the obtained ginkgo distilled liquor was about 45%.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

### INDUSTRIAL APPLICABILITY

Fermented ginkgo liquor prepared according to a method of the present invention uses ginkgo's own glucose as a source material for fermentation through pre-treatment with α-amylase. In this regard, a glucose concentration measured before fermentation starts is increased to facilitate alcohol fermentation, and accordingly, fermented liquor prepared therefrom may have improved commercial value with increased transparency. In addition, the ginkgo fermented liquor of the present invention has pharmacological functions including capability of improving blood circulation, through ginkgo's natural physiologically active materials, thereby allowing application of the ginkgo fermented liquor as functional liquor.

1. A method of preparing ginkgo fermented liquor, the method comprising:
preparing ginkgo hydrolysate by mixing ginkgo with heat-tolerant amylase to allow an enzyme reaction at a temperature from about 70° C. to about 100° C.; and
mixing the ginkgo hydrolysate with a fermentation strain to allow fermentation.

2. The method of claim 1, wherein the heat-tolerant amylase is α-amylase derived from a Thermotoga maritime strain.

3. The method of claim 1, wherein enzyme reaction in the preparing of the ginkgo hydrolysate is performed by applying a microwave thereto at a temperature from about 85° C. to about 95° C. in a microwave.

4. The method of claim 1, further comprising:
preparing ginkgo oligosaccharide from a supernatant obtained by centrifugation of the ginkgo hydrolysate,
wherein the ginkgo oligosaccharide is mixed with a fermentation strain to allow fermentation.

5. The method of claim 1, wherein the fermentation strain is yeast, aspergillus, or a mixture thereof.

6. The method of claim 1, wherein the fermentation is performed at room temperature.

7. The method of claim 1, wherein at least one selected from the group consisting of rice, barley, corn, potato, sweet potato, foxtail millet, sorghum, proso millet, and bean is further mixed with the ginkgo hydrolysate to allow fermentation.

8. A method of preparing a ginkgo brandy, the method comprising:
distilling the ginkgo fermented liquor prepared according to the method of claim 1.

9. Fermented ginkgo liquor prepared according to the method of claim 1.

10. Ginkgo brandy prepared according to the method of claim 8.
